(19) United States
(12) Patent Application Publication
(10) Pub. No.: US 2026/0247241 A1
(43) Pub. Date: Aug. 20, 2026

(54) CPU EFFICIENT SATELLITE HANDOVER USING SELECTIVE ERROR CORRECTION

(71) Applicant: Kratos Integral Holdings LLC, San Diego, CA (US)

(72) Inventors: Markus Eslitzbichler, Drammen (NO); Matthew Allen Reklau, Centreville, VA (US)

(21) Appl. No.: 19/056,053

(22) Filed: Feb. 18, 2025

(51) Int. Cl. H04W 36/08; H04B 7/185; H04W 36/02

(52) U.S. Cl. CPC H04W 36/083; H04B 7/18541; H04W 36/02

(57) ABSTRACT

Described herein are systems, methods, and other techniques for transferring communication from a source satellite to a target satellite. The method includes communicating user traffic between first and second virtual modems running on different communication units via the source satellite. The method also includes communicating non-user traffic between the first and second virtual modems via the target satellite while the user traffic is being communicated via the source satellite, where error correction decoding is performed at the first and second virtual modems while communicating payload data of the user traffic via the source satellite but not while communicating payload data of the non-user traffic via the target satellite. The method further includes transferring communication of the user traffic from the source satellite to the target satellite to begin communicating the user traffic between the first and second virtual modems via the target satellite.

### BACKGROUND OF THE INVENTION

Satellite communication systems play an important role in facilitating global connectivity across diverse applications, including telecommunications, broadcasting, internet services, and remote sensing. These systems operate by transmitting signals between ground-based Earth stations and satellites in orbit. The efficiency and reliability of such systems are important to addressing the increasing demands of contemporary communication and data services. Presently, communications engineers encounter numerous challenges, with a key concern being the optimization of information transmission over limited resources. Given the scarcity of available frequencies for radio signal communication and the rapid growth in the volume of information to be conveyed, there is a need to maximize the efficiency of available frequencies through the use of new hardware and software solutions at the ground stations, terminals, and satellites that make up such communication systems.

### SUMMARY OF THE INVENTION

The present disclosure broadly relates to techniques for performing a satellite handover or handoff. More particularly, the present disclosure provides techniques for transferring communication from a source satellite to a target satellite using selective error correction to reduce compute consumption. A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of transferring communication from a source satellite to a target satellite, the method comprising: running a first virtual modem at a first communication unit and a second virtual modem at a second communication unit; communicating user traffic between the first virtual modem and the second virtual modem via the source satellite; communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and transferring communication of the user traffic from the source satellite to the target satellite to begin communicating the user traffic between the first virtual modem and the second virtual modem via the target satellite.

Example 2 is the method of example(s) 1, wherein the first communication unit is a gateway and the second communication unit is a terminal.

Example 3 is the method of example(s) 1-2, wherein the user traffic is communicated via the source satellite using a first antenna of the first communication unit and the non-user traffic is communicated via the target satellite using a second antenna of the first communication unit.

Example 4 is the method of example(s) 1-3, wherein the non-user traffic comprises dummy frames.

Example 5 is the method of example(s) 4, wherein communicating the non-user traffic via the target satellite includes: performing, at the first virtual modem and the second virtual modem, error correction encoding to header data of the dummy frames; performing, at the first virtual modem and the second virtual modem, error correction decoding to the header data of the dummy frames.

Example 6 is the method of example(s) 1-5, wherein: the user traffic is communicated via the source satellite during a first time window; the non-user traffic is communicated via the target satellite during a second time window that at least partially overlaps with the first time window; and the user traffic is communicated via the target satellite during a third time window after the first time window and the second time window.

Example 7 is the method of example(s) 6, wherein, during the first time window: the first virtual modem includes: a first virtual transmitter that includes a first error correction encoder and a first modulator; and a first virtual receiver that includes a first error correction decoder and a first demodulator; and the second virtual modem includes: a second virtual transmitter that includes a second error correction encoder and a second modulator; and a second virtual receiver that includes a second error correction decoder and a second demodulator.

Example 8 is the method of example(s) 7, wherein, during the second time window: the first virtual modem further includes: a third virtual transmitter that includes a third error correction encoder and a third modulator; and a third virtual receiver that includes a third demodulator; and the second virtual modem further includes: a fourth virtual transmitter that includes a fourth error correction encoder and a fourth modulator; and a fourth virtual receiver that includes a fourth demodulator.

Example 9 is one or more non-transitory computer-readable media comprising instructions that, when executed by one or more processors, cause the one or more processors to perform operations for transferring communication from a source satellite to a target satellite, the operations comprising: running a first virtual modem at a first communication unit and a second virtual modem at a second communication unit; communicating user traffic between the first virtual modem and the second virtual modem via the source satellite; communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and transferring communication of the user traffic from the source satellite to the target satellite to begin communicating the user traffic between the first virtual modem and the second virtual modem via the target satellite.

Example 10 is the one or more non-transitory computer-readable media of example(s) 9, wherein the first communication unit is a gateway and the second communication unit is a terminal.

Example 11 is the one or more non-transitory computer-readable media of example(s) 9-10, wherein the user traffic is communicated via the source satellite using a first antenna of the first communication unit and the non-user traffic is communicated via the target satellite using a second antenna of the first communication unit.

Example 12 is the one or more non-transitory computer-readable media of example(s) 9-11, wherein the non-user traffic comprises dummy frames.

Example 13 is the one or more non-transitory computer-readable media of example(s) 12, wherein communicating the non-user traffic via the target satellite includes: performing, at the first virtual modem and the second virtual modem, error correction encoding to header data of the dummy frames; performing, at the first virtual modem and the second virtual modem, error correction decoding to the header data of the dummy frames.

Example 14 is the one or more non-transitory computer-readable media of example(s) 9-13, wherein: the user traffic is communicated via the source satellite during a first time window; the non-user traffic is communicated via the target satellite during a second time window that at least partially overlaps with the first time window; and the user traffic is communicated via the target satellite during a third time window after the first time window and the second time window.

Example 15 is the one or more non-transitory computer-readable media of example(s) 14, wherein, during the first time window: the first virtual modem includes: a first virtual transmitter that includes a first error correction encoder and a first modulator; and a first virtual receiver that includes a first error correction decoder and a first demodulator; and the second virtual modem includes: a second virtual transmitter that includes a second error correction encoder and a second modulator; and a second virtual receiver that includes a second error correction decoder and a second demodulator.

Example 16 is the one or more non-transitory computer-readable media of example(s) 15, wherein, during the second time window: the first virtual modem further includes: a third virtual transmitter that includes a third error correction encoder and a third modulator; and a third virtual receiver that includes a third demodulator; and the second virtual modem further includes: a fourth virtual transmitter that includes a fourth error correction encoder and a fourth modulator; and a fourth virtual receiver that includes a fourth demodulator.

Example 17 is a system comprising: one or more processors; and one or more computer-readable media comprising instructions that, when executed by the one or more processors, cause the one or more processors to perform operations for transferring communication from a source satellite to a target satellite, the operations comprising: running a first virtual modem at a first communication unit and a second virtual modem at a second communication unit; communicating user traffic between the first virtual modem and the second virtual modem via the source satellite; communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and transferring communication of the user traffic from the source satellite to the target satellite to begin communicating the user traffic between the first virtual modem and the second virtual modem via the target satellite.

Example 18 is the system of example(s) 17, wherein the first communication unit is a gateway and the second communication unit is a terminal.

Example 19 is the system of example(s) 17-18, wherein the user traffic is communicated via the source satellite using a first antenna of the first communication unit and the non-user traffic is communicated via the target satellite using a second antenna of the first communication unit.

Example 20 is the system of example(s) 17-19, wherein the non-user traffic comprises dummy frames.

Example 21 is the system of example(s) 20, wherein communicating the non-user traffic via the target satellite includes: performing, at the first virtual modem and the second virtual modem, error correction encoding to header data of the dummy frames; performing, at the first virtual modem and the second virtual modem, error correction decoding to the header data of the dummy frames.

Example 22 is the system of example(s) 17-21, wherein: the user traffic is communicated via the source satellite during a first time window; the non-user traffic is communicated via the target satellite during a second time window that at least partially overlaps with the first time window; and the user traffic is communicated via the target satellite during a third time window after the first time window and the second time window.

Example 23 is the system of example(s) 22, wherein, during the first time window: the first virtual modem includes: a first virtual transmitter that includes a first error correction encoder and a first modulator; and a first virtual receiver that includes a first error correction decoder and a first demodulator; and the second virtual modem includes: a second virtual transmitter that includes a second error correction encoder and a second modulator; and a second virtual receiver that includes a second error correction decoder and a second demodulator.

Example 24 is the system of example(s) 23, wherein, during the second time window: the first virtual modem further includes: a third virtual transmitter that includes a third error correction encoder and a third modulator; and a third virtual receiver that includes a third demodulator; and the second virtual modem further includes: a fourth virtual transmitter that includes a fourth error correction encoder and a fourth modulator; and a fourth virtual receiver that includes a fourth demodulator.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example satellite handover at a satellite communication system having a gateway and a terminal.

FIG. 2 illustrates an example satellite handover at a satellite communication system having a gateway and a terminal.

FIGS. 3A-3C illustrates an example satellite handover utilizing selective error correction at a satellite communication system having a gateway and a terminal.

FIG. 4 illustrates an example of selective FEC encoding at a virtual transmitter running at a communication unit while communicating non-user traffic.

FIG. 5 illustrates an example communication path between end points enabled by a satellite communication system.

FIG. 6 illustrates an example satellite communication system including a gateway and a set of terminals.

FIG. 7 illustrates an example digital IF packet with multiple protocol layers.

FIG. 8 illustrates an example method of transferring communication from a source satellite to a target satellite.

FIG. 9 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

A satellite handover, also known as a satellite handoff, is a process in which an ongoing communication session is transferred from one satellite to another. This typically occurs when the satellite currently supporting the communication session moves out of range of the gateway or remote terminal, and another satellite within the constellation is available to take over the communication session without interruption. This process allows continuous and seamless connectivity, especially in satellite communication systems and constellations with multiple satellites providing coverage to large geographical areas. A make-before-break handover, also known as a soft handover, is a type of satellite handover in which the new communication link with a different satellite is established before the existing link is terminated. In this approach, the gateway and terminal maintain simultaneous connections with both the current satellite and the new satellite during the handover.

During operation of a satellite communication system, the system may continuously monitor parameters such as signal strength, quality of service, and the position of satellites relative to the gateway or terminal. When these parameters indicate that a handover is necessary (e.g., a current or source satellite is moving out of range), the handover process may be initiated. A new connection is then established with the target satellite by, for example, setting up the necessary communication channels, synchronizing the new link with the ongoing session, performing a signal lock at each of the demodulators, and ensuring that all necessary protocol handshakes are completed. In some cases, the terminal or gateway may include two separate antennas, a first antenna for communicating via the source satellite while a second antenna locks to the target satellite.

For a brief period, the terminal and gateway may maintain dual connectivity, communicating with both the source and target satellites. This overlap period (or “handover period”) ensures that there is always an active link, thereby minimizing the risk of dropped connections. The system may gradually transfer the user traffic from the old connection to the new one. This may include rerouting data streams and updating network routing tables. Once the new connection is fully established and stable, the old connection is terminated. The terminal or gateway may continue communicating through the new link without any disruption to the user.

Maintaining two simultaneous connections during the handover period can be computationally burdensome for the compute infrastructure at the terminal and gateway. In particular, two demodulators running side-by-side (at both the terminal and gateway, i.e., four demodulators in total) can consume a significant amount of central processing unit (CPU) resources. Another significant consumer of CPU resources comes from the use of forward error correction (FEC) decoders that receive the output bits from the demodulators and perform error detection and correction on the received data. While FEC decoding is important to improve the bit error rate of user traffic, the data that is communicated via the target satellite during the handover period may include dummy or placeholder frames that may not need error correction.

Embodiments of the present disclosure relate to systems and methods for transferring communication from a source satellite to a target satellite using selective error correction to reduce CPU consumption. During the handover period, user traffic continues to be communicated via the source satellite through the pre-existing link and non-user traffic is communicated via the target satellite while the new communication link is being established. Non-user traffic payload data sent via the target satellite during link establishment does not need to be FEC encoded prior to transmission. At the receiving ends, the FEC decoders may be deactivated for the payload data of the non-user traffic as such data is not used by downstream processes. Once both receivers have achieved a lock onto the new communication link, the FEC decoders may be activated as user traffic begins to be communicated through the new channel.

Many benefits are achieved by way of present disclosure. For example, the use of dummy frames and optimized forward error correction can minimize compute costs and enable seamless handover between satellites in different orbits. As FEC decoding is a dominant processing step that consumes significant computing power, deactivating FEC decoding for demodulated payload data while only decoding the frame headers can reduce CPU usage and costs and open up CPU resources for other processes. Dummy frames as used herein may include a fixed sequence of data that only contain useful information in the header. Forward error correction may be applied to the header of each frame, while the payload is left untouched. Optionally, dummy frames may be solely modulated signals with no FEC correction applied, further minimizing compute costs. In a software-based system, the modulator and demodulator can be dynamically sized as communication channels are initialized and terminated, further saving hardware and other resources.

Embodiments of the present disclosure are particularly suitable for satellite communication systems that employ digital intermediate frequency (IF) technology, which entails the transmission of analog IF data onto Internet Protocol (IP)-based networks. Digital IF offers the potential to introduce much-needed flexibility in ground station architectures. In some cases, through the use of IF digitizers and cloud processing resources, much of the conventional ground station architecture (typically consisting of an antenna, amplifiers, frequency converters, and a string of RF switches, modems, and other processing equipment) can be virtualized. The capability to digitize and transmit RF signals in real-time, without data loss, effectively eliminates the constraints of distance and signal degradation associated with analog RF. Overcoming these limitations has been a significant challenge for operators aiming to optimize infrastructure investments and leverage the latest technologies, whether it involves transitioning ground systems to the cloud, centralizing (or decentralizing) operations, or mitigating service interruptions caused by atmospheric effects.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

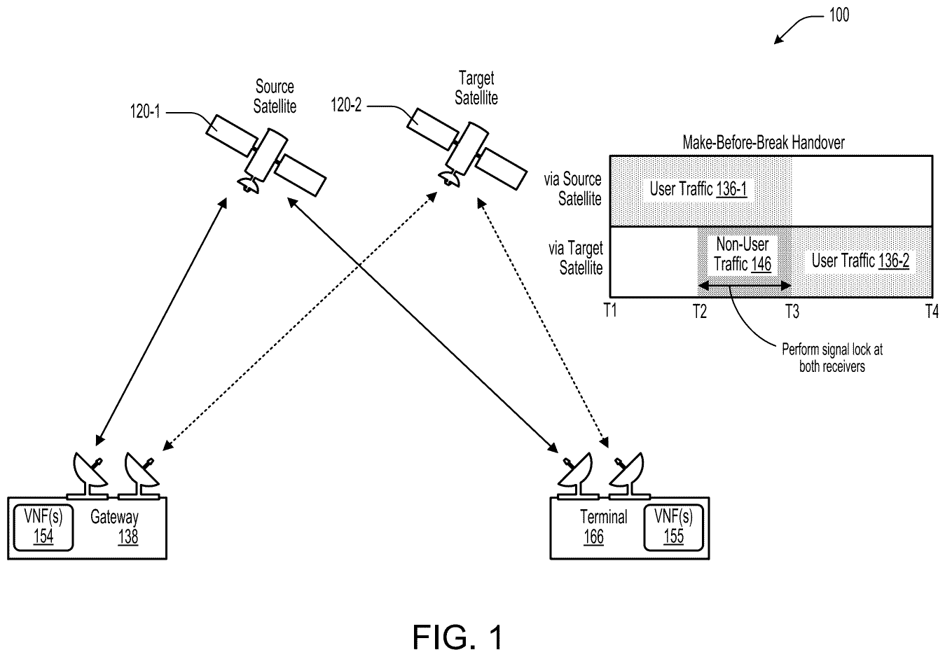

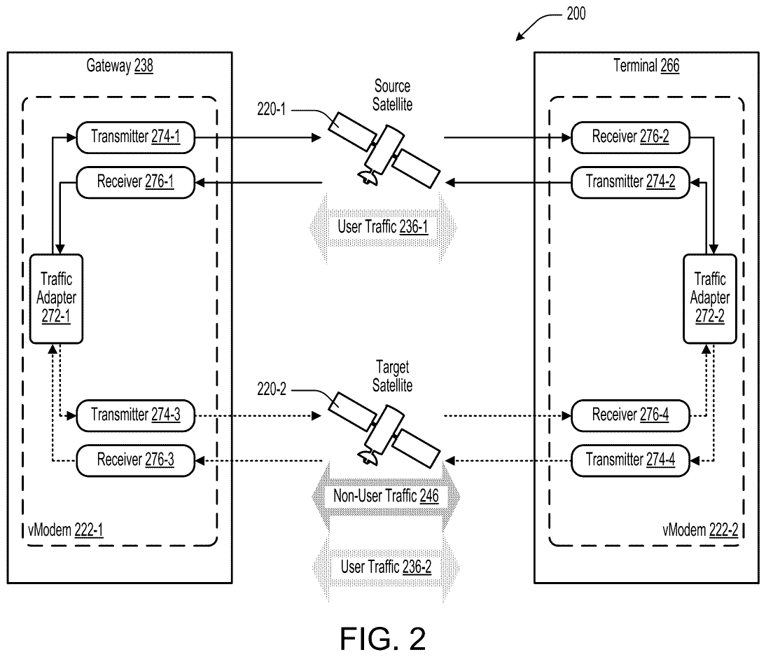

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example satellite handover at a satellite communication system 100 having a gateway 138 and a terminal 166, in accordance with some embodiments of the present disclosure. Each of gateway 138 and terminal 166 may employ digital IF technology in which analog IF data may be processed and transmitted along IP-based connections. For example, gateway 138 may include a compute infrastructure running one or more virtual network functions (VNFs) 154 and terminal 166 may include a compute infrastructure running one or more VNFs 155. In some examples, VNFs 154 and 155 may include virtual modems, modulators, demodulators, FEC encoders, FEC decoders, traffic adapters, among other possibilities.

In the illustrated example, during a first time window between times T1 and T3, gateway 138 and terminal 166 unidirectionally or bidirectionally communicate user traffic 136-1 via a source satellite 120-1. User traffic 136-1 may include voice traffic (e.g., telephone or voice over IP (VoIP) communications), video traffic (e.g. video calls, streaming services, video conferencing, etc.), internet traffic (e.g., web browsing, email, file transfers, social media interactions, online applications, etc.), and/or messaging traffic (text messages and other text-based communication). At gateway 138, user traffic 136-1 may be transmitted/received using a first antenna of gateway 138, and at terminal 166, user traffic 136-1 may be transmitted/received using a first antenna of terminal 166. During the first time window, such as just prior to time T2, gateway 138 or terminal 166 may determine that a satellite handover process from source satellite 120-1 to a target satellite 120-2 may need to take place due to, for example, an increased distance from source satellite 120-1 to gateway 138 or terminal 166.

At time T2, the satellite handover process is initialized. During a second time window between times T2 and T3, which at least partially overlaps with the first time window between times T1 and T3, gateway 138 and terminal 166 unidirectionally or bidirectionally communicate non-user traffic 146 via a target satellite 120-2. In some examples, non-user traffic 146 may include data that is not directly related to the end-user's communication activities. Instead, non-user traffic 146 may include information used for the control and management of satellite communication system 100. In some examples, non-user traffic 146 includes dummy or placeholder frames that do not carry any user data. At gateway 138, non-user traffic 146 may be transmitted/received using a second antenna of gateway 138 (or, in some examples, the first antenna of gateway 138 may be used for both communication links), and at terminal 166, non-user traffic 146 may be transmitted/received using a second antenna of terminal 166 (or, in some examples, the first antenna of terminal 166 may be used for both communication links). Communication of non-user traffic 146 can be used to achieve lock on the second channel via target satellite 120-2. For example, the second antennas of gateway 138 and terminal 166 may be pointed to and begin tracking target satellite 120-2 during the second time window between times T2 and T3.

During a third time window between times T3 and T4, gateway 138 and terminal 166 unidirectionally or bidirectionally communicate user traffic 136-2 via target satellite 120-2. For example, at time T3, communication of user traffic 136 may be transferred from source satellite 120-1 to target satellite 120-2. The transfer of user traffic 136 at time T3 may be immediate such that user traffic 136-1 and 136-2 contain no overlapping user data or, in some examples, a brief period of parallel communication of user data may take place such that user traffic 136-1 and 136-2 contain at least some overlapping user data. Similar to user traffic 136-1, user traffic 136-2 may include voice traffic, video traffic, internet traffic, and/or messaging traffic. It is to be understood that additional satellite handover processes may take place in a similar manner to ensure continuous communication of user traffic 136 between gateway 138 and terminal 166.

FIG. 2 illustrates an example satellite handover at a satellite communication system 200 having a gateway 238 and a terminal 266, in accordance with some embodiments of the present disclosure. Gateway 238 and terminal 266 may include compute infrastructures running VNFs that respectively include virtual modems 222-1 and 222-2. During a first time window, gateway 238 may instantiate a virtual transmitter 274-1, a virtual receiver 276-1, and a traffic adapter 272-1 within virtual modem 222-1 and terminal 266 may instantiate a virtual transmitter 274-2, a virtual receiver 276-2, and a traffic adapter 272-2 within virtual modem 222-2. The functionalities of virtual transmitters, virtual receivers, and traffic adapters are described in detail elsewhere herein. During the first time window, user traffic 236-1 is communicated between virtual modem 222-1 running on gateway 238 and virtual modem 222-2 running on terminal 266 by, for example, virtual transmitter 274-1 transmitting baseband frames containing user data to virtual receiver 276-2 via source satellite 220-1 and virtual transmitter 274-2 transmitting baseband frames containing user data to virtual receiver 276-1 via source satellite 220-1.

During a second time window that at least partially overlaps with the first time window, gateway 238 and terminal 266 may determine that the satellite handover process is to take place. In response to determining that the satellite handover process is to take place, and during the second time window, gateway 238 may instantiate a virtual transmitter 274-3 and a virtual receiver 276-3 within virtual modem 222-1 and terminal 266 may instantiate a virtual transmitter 274-4 and a virtual receiver 276-4 within virtual modem 222-2. During the second time window, non-user traffic 246 is communicated between virtual modem 222-1 running on gateway 238 and virtual modem 222-2 running on terminal 266 by, for example, virtual transmitter 274-3 transmitting dummy baseband or physical layer frames containing placeholder data to virtual receiver 276-4 via target satellite 220-2 and virtual transmitter 274-4 transmitting dummy baseband frames containing placeholder data to virtual receiver 276-3 via target satellite 220-2. Non-user traffic 246 may continue to be communicated between virtual modems 222-1 and 222-2 until each of gateway 238 and terminal 266 have achieved a signal lock onto target satellite 220-2.

During a third time window after the second time window (and either following the first time window or at least partially overlapping with the first time window), user traffic 236-2 is communicated between virtual modem 222-1 running on gateway 238 and virtual modem 222-2 running on terminal 266 by, for example, virtual transmitter 274-3 transmitting baseband frames containing user data to virtual receiver 276-4 via target satellite 220-2 and virtual transmitter 274-4 transmitting baseband frames containing user data to virtual receiver 276-3 via target satellite 220-2. Accordingly, during the third time window, non-user traffic 246 is no longer communicated between virtual modems 222-1 and 222-2.

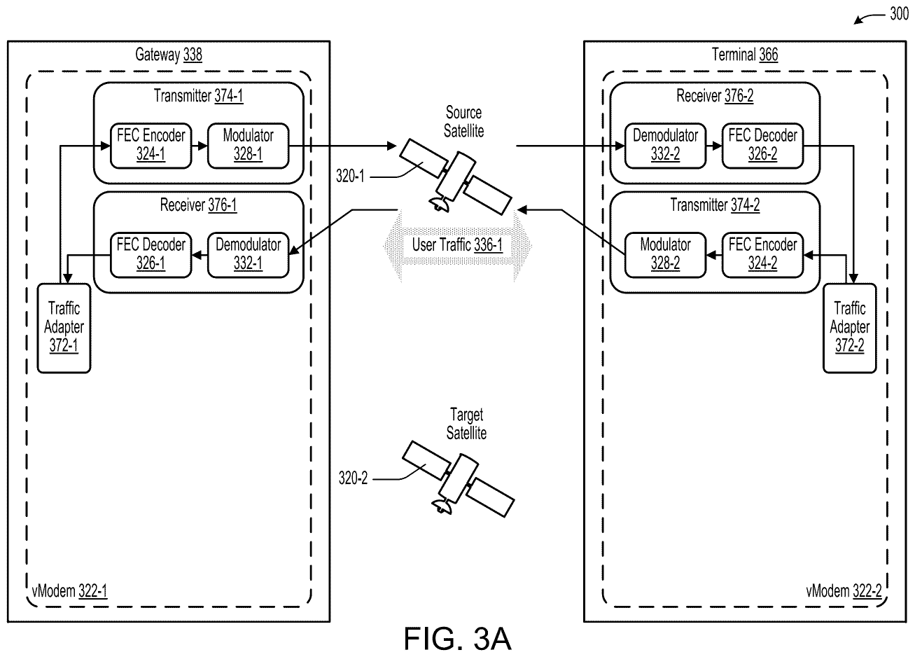

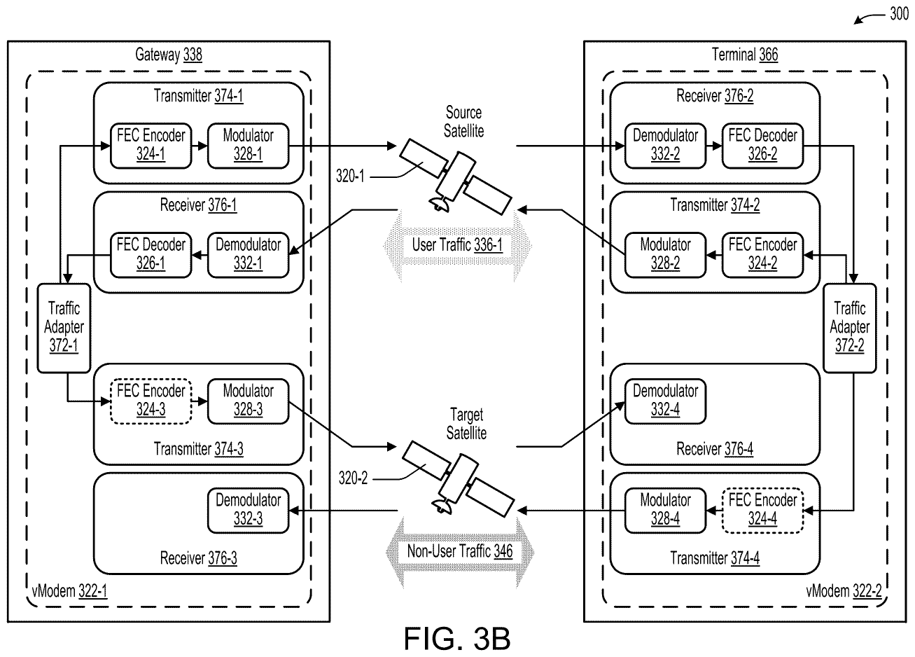

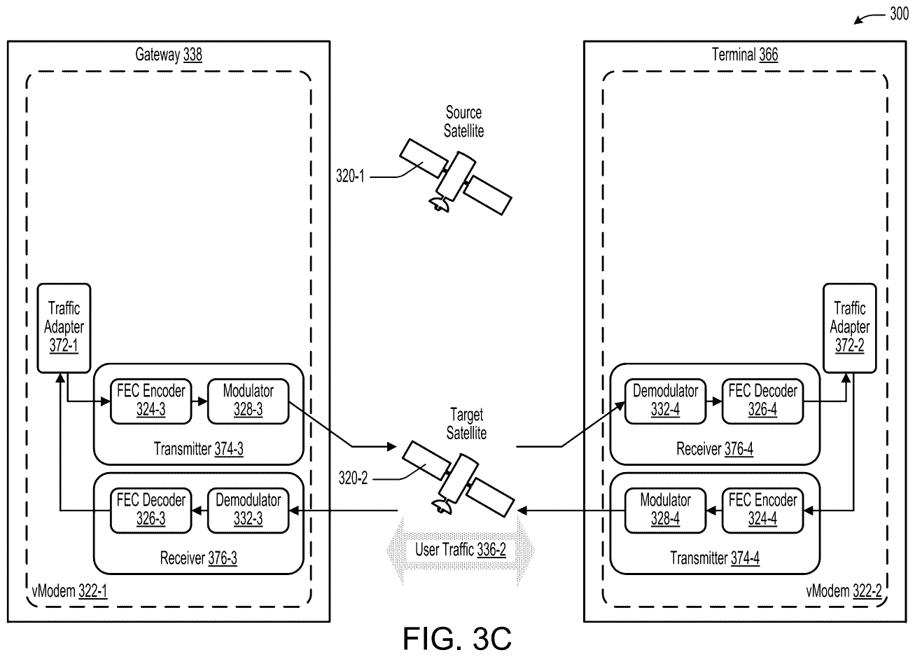

FIGS. 3A-3C illustrates an example satellite handover utilizing selective error correction at a satellite communication system 300 having a gateway 338 and a terminal 366, in accordance with some embodiments of the present disclosure. Gateway 338 and terminal 366 may include compute infrastructures running VNFs that respectively include virtual modems 322-1 and 322-2. FIG. 3A illustrates events taking place at least during a first time window. In particular, FIG. 3A illustrates the communication of user traffic 336-1 between virtual modems 322-1 and 322-2 via a source satellite 320-1. During the first time window, gateway 338 may instantiate a virtual transmitter 374-1, a virtual receiver 376-1, and a traffic adapter 372-1 within virtual modem 322-1 and terminal 366 may instantiate a virtual transmitter 374-2, a virtual receiver 376-2, and a traffic adapter 372-2 within virtual modem 322-2. In some examples, virtual transmitter 374-1 may include an FEC encoder 324-1 and a modulator 328-1, virtual receiver 376-1 may include an FEC decoder 326-1 and a demodulator 332-1, virtual transmitter 374-2 may include an FEC encoder 324-2 and a modulator 328-2, and virtual receiver 376-2 may include an FEC decoder 326-2 and a demodulator 332-2.

In FIG. 3A, user traffic 336-1 is communicated bidirectionally between virtual modem 322-1 running on gateway 338 and virtual modem 322-2 running on terminal 366 via source satellite 320-1. In a first direction, baseband frames containing user data are passed from traffic adapter 372-1 to virtual transmitter 374-1, which uses FEC encoder 324-1 to add redundancy to the baseband frames based on an error-correcting code and modulator 328-1 to modulate the encoded baseband frames. The modulated and encoded baseband frames are transmitted via source satellite 320-1 to virtual receiver 376-2, which uses demodulator 332-2 to demodulate the received baseband frames and FEC decoder 326-2 to detect and/or correct errors in the demodulated baseband frames. The decoded baseband frames are then passed to traffic adapter 372-2. In the opposite direction, baseband frames containing user data are passed from traffic adapter 372-2 to virtual transmitter 374-2, which uses FEC encoder 324-2 to add redundancy to the baseband frames based on an error-correcting code and modulator 328-2 to modulate the encoded baseband frames. The modulated and encoded baseband frames are transmitted via source satellite 320-1 to virtual receiver 376-1, which uses demodulator 332-1 to demodulate the received baseband frames and FEC decoder 326-1 to detect and/or correct errors in the demodulated baseband frames. The decoded baseband frames are then passed to traffic adapter 372-1.

FIG. 3B illustrates events taking place at least during a second time window. In particular, FIG. 3B illustrates the communication of non-user traffic 346 between virtual modems 322-1 and 322-2 via a target satellite 320-2 while user traffic 336-1 continues to be communicated via source satellite 320-1 as described in FIG. 3A. In some examples, gateway 338 and terminal 366 may determine that the satellite handover process is to take place. In response, during the second time window, gateway 338 may instantiate a virtual transmitter 374-3 and a virtual receiver 376-3 within virtual modem 322-1 and terminal 366 may instantiate a virtual transmitter 374-4 and a virtual receiver 376-4 within virtual modem 322-2. In some examples, virtual transmitter 374-3 may include an FEC encoder 324-3 and a modulator 328-3, virtual receiver 376-3 may include a demodulator 332-3, virtual transmitter 374-4 may include an FEC encoder 324-4 and a modulator 328-4, and virtual receiver 376-4 may include a demodulator 332-4. In other examples, the FEC encoders may not be instantiated such that virtual transmitter 374-3 may include modulator 328-3 but not FEC encoder 324-3 and virtual transmitter 374-4 may include modulator 328-4 but not FEC encoder 324-4.

In FIG. 3B, non-user traffic 346 is communicated bidirectionally between virtual modem 322-1 running on gateway 338 and virtual modem 322-2 running on terminal 366 via target satellite 320-2. In a first direction, dummy baseband frames containing placeholder data are passed from traffic adapter 372-1 to virtual transmitter 374-3, which optionally uses FEC encoder 324-3 to add redundancy to the headers of the baseband frames based on an error-correcting code and modulator 328-3 to modulate the baseband frames. The modulated baseband frames are transmitted via target satellite 320-2 to virtual receiver 376-4, which uses demodulator 332-4 to demodulate the received baseband frames. Demodulator 332-4 uses the received baseband frames to achieve a signal lock onto target satellite 320-2 and does not pass the demodulated baseband frames onto another VNF at virtual modem 322-2. Optionally, in some examples, demodulator 332-4 may perform FEC decoding on the headers of the received baseband frames to determine, based on one or more fields in the headers, that the received baseband frames are dummy baseband frames containing placeholder data and therefore do not need to be passed onto another VNF at virtual modem 322-2.

In the opposite direction, dummy baseband frames containing placeholder data are passed from traffic adapter 372-2 to virtual transmitter 374-4, which optionally uses FEC encoder 324-4 to add redundancy to the headers of the baseband frames based on an error-correcting code and modulator 328-4 to modulate the baseband frames. The modulated baseband frames are transmitted via target satellite 320-2 to virtual receiver 376-3, which uses demodulator 332-3 to demodulate the received baseband frames. Demodulator 332-3 uses the received baseband frames to achieve a signal lock onto target satellite 320-2 and does not pass the demodulated baseband frames onto another VNF at virtual modem 322-1. Optionally, in some examples, demodulator 332-3 may perform FEC decoding on the headers of the received baseband frames to determine, based on one or more fields in the headers, that the received baseband frames are dummy baseband frames containing placeholder data and therefore do not need to be passed onto another VNF at virtual modem 322-1. By not instantiating FEC decoders in virtual receivers 376-3 and 376-4, significant compute costs can be saved at the compute infrastructures of gateway 338 and terminal 366 while non-user traffic 346 is being communicated.

FIG. 3C illustrates events taking place at least during a third time window. In particular, FIG. 3C illustrates the communication of user traffic 336-2 between virtual modems 322-1 and 322-2 via target satellite 320-2 after the communication of user traffic 336 has been transferred from source satellite 320-1 to target satellite 320-2. In some examples, user traffic 336-2 is communicated via target satellite 320-2 upon each of gateway 338 and terminal 366 achieving a signal lock onto target satellite 320-2. During the third time window, gateway 338 may instantiate an FEC decoder 326-3 within virtual receiver 376-3 and an FEC decoder 326-4 within virtual receiver 376-4. Further during the third time window, gateway 338 may terminate virtual transmitter 374-1 and virtual receiver 376-1 (as well as any VNFs contained therein) within virtual modem 322-1 and terminal 366 may terminate virtual transmitter 374-2 and virtual receiver 376-2 (as well as any VNFs contained therein) within virtual modem 322-2.

In FIG. 3C, user traffic 336-2 is communicated bidirectionally between virtual modem 322-1 running on gateway 338 and virtual modem 322-2 running on terminal 366 via target satellite 320-2. In a first direction, baseband frames containing user data are passed from traffic adapter 372-1 to virtual transmitter 374-3, which uses FEC encoder 324-3 to add redundancy to the baseband frames based on an error-correcting code and modulator 328-3 to modulate the encoded baseband frames. The modulated and encoded baseband frames are transmitted via target satellite 320-2 to virtual receiver 376-4, which uses demodulator 332-4 to demodulate the received baseband frames and FEC decoder 326-4 to detect and/or correct errors in the demodulated baseband frames. The decoded baseband frames are then passed to traffic adapter 372-2. In the opposite direction, baseband frames containing user data are passed from traffic adapter 372-2 to virtual transmitter 374-4, which uses FEC encoder 324-4 to add redundancy to the baseband frames based on an error-correcting code and modulator 328-4 to modulate the encoded baseband frames. The modulated and encoded baseband frames are transmitted via target satellite 320-2 to virtual receiver 376-3, which uses demodulator 332-3 to demodulate the received baseband frames and FEC decoder 326-3 to detect and/or correct errors in the demodulated baseband frames. The decoded baseband frames are then passed to traffic adapter 372-1.

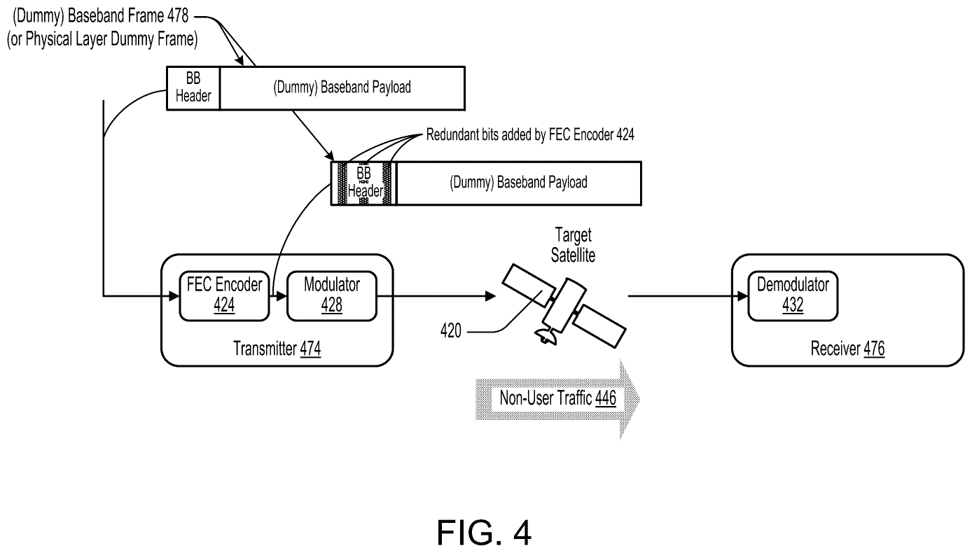

FIG. 4 illustrates an example of selective FEC encoding at a virtual transmitter 474 running at a communication unit while communicating non-user traffic 446, in accordance with some embodiments of the present disclosure. The communication unit running virtual transmitter 474 may be a gateway or a terminal. Virtual transmitter 474 may receive a dummy baseband frame 478 (e.g., a physical layer dummy frame) from a traffic adapter. Baseband frame 478 may include a header and a payload. In some examples, the header may include one or more fields indicating that baseband frame 478 is a dummy baseband frame or a physical layer dummy frame that holds placeholder data or non-user data in its payload. In some examples, virtual transmitter 474 may use an FEC encoder 424 to add redundancy to baseband frame 478 (e.g., the header of baseband frame 478) based on a particular error-correcting code. Examples of error-correcting codes include Hamming codes, Reed-Solomon codes, convolutional codes, turbo codes, polar codes, low-density parity-check (LDPC) codes, among other possibilities. FEC encoder 424 may skip over or ignore the payload of baseband frame 478 without performing FEC encoding or, in some examples, to reduce complexity, FEC encoder 424 may apply FEC encoding to both the header and the payload of baseband frame 478.

A modulator 428 of virtual transmitter 474 may be used to modulate baseband frame 478 that is output by FEC encoder 424. After modulation, baseband frame 478 is transmitted via a target satellite 420 to a virtual receiver 476, which may be running at a second communication unit. The communication unit running virtual receiver 476 may be a gateway or a terminal. Virtual receiver 476 uses a demodulator 432 to demodulate baseband frame 478. Demodulator 432 uses baseband frame 478 as well as additional received baseband frames to achieve a signal lock onto target satellite 420 and does not pass the demodulated baseband frames onto another VNF. Demodulator 432 may perform FEC decoding on the header of baseband frame 478 to determine, based on one or more fields in the header, that baseband frame 478 is a dummy baseband frame containing placeholder data.

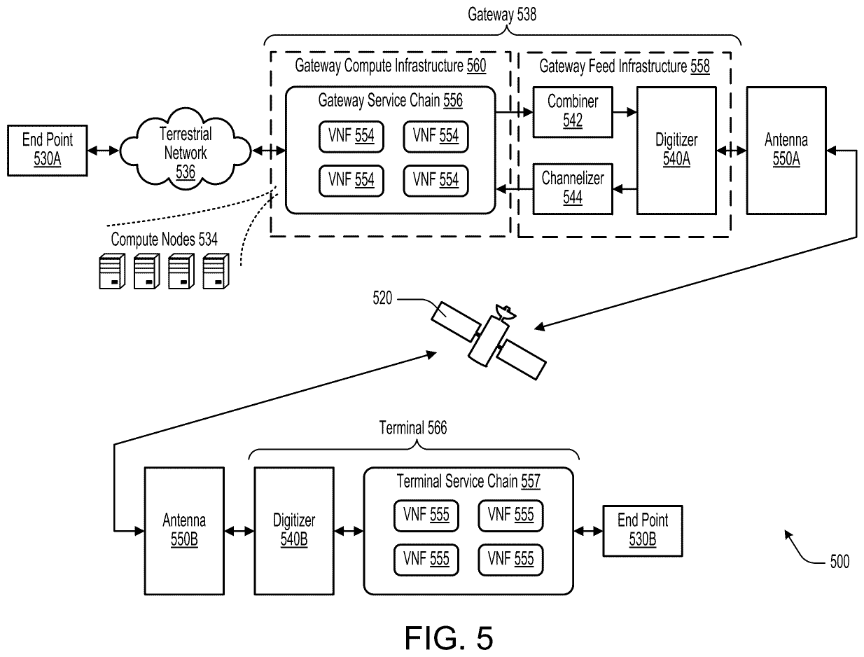

FIG. 5 illustrates an example communication path between an end point 530A and an end point 530B enabled by a satellite communication system 500, in accordance with some embodiments of the present disclosure. In the illustrated example, satellite communication system 500 includes a gateway 538 in communication with a terminal 566 via a satellite 520. In various examples, satellite 520 may send and receive wireless signals within one or more bands of a number of possible frequency bands between approximately 0.9-300 GHz including, for example, L Band (0.95-2.45 GHz), S-Band (2-4 GHz), C-Band (4-8 GHz), X-Band (8-12 GHz), Ku-Band (12-18 GHz), Ka-Band (26.5-40 GHz), and V-Band (40-75 GHz).

In various examples, end points 530 may correspond to portable mobile devices, internet of things (IoT) devices, desktop computers, user terminals, or any of a number of devices with communication capabilities. Alternatively, end points 530 may correspond to networks such as mobile towers, mining sites, ships, planes, or the like. In one example, end point 530A may correspond to a service and end point 530B may correspond to a consumer. It should be understood that the satellite communication environment may comprise other end points 510 and/or other arrangements of components than those illustrated. Furthermore, multiple communication paths may be constructed and operated in parallel, and separate communication paths may have different arrangements from each other.

End point 530A may be communicatively connected via a terrestrial network 536 (e.g., comprising the Internet, a private telecom backbone, or a cloud compute center) to a gateway 538. Gateway 538 may include one or more switches (not shown) to facilitate communication between the various components, such as a first switch at the boundary between terrestrial network 536 and a gateway compute infrastructure 560, and a second switch at the boundary between gateway compute infrastructure 560 and a gateway feed infrastructure 558. Such switches may be physical or virtual Gigabit Ethernet (GigE) switches. However, it should be understood that the above-described first and second switches could be implemented in the same switch. In some examples, the first switch may implement transport from terrestrial network 536 to a VNF 554 within a gateway service chain 556. In such a case, VNF 554 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 560 may include a set of compute nodes 534 situated onsite (at a same physical location) or offsite (at a different physical location) relative to antenna 550. In some examples, compute nodes 534 may comprise general-purpose computers or servers capable of running VNFs 554 (e.g., as workloads) and other virtualization software such as hypervisors to support gateway service chain 556. In some examples, compute nodes 534 may employ x86 architectures, ARM architectures, RISC-V architectures, among other possibilities. Compute nodes 534 may be configured as clusters, data centers, warehouse-scale computers, among other possibilities. Gateway compute infrastructure 560 may further include suitable storage systems that provide persistent and reliable storage in support of VNFs 554.

In some examples, gateway compute infrastructure 560 may include a managing system that instantiates and configures one or more VNFs 554 to form gateway service chain 556. Two sets of one or more VNFs 554 may provide two-way communication, including a transmission path and a reception path, between terrestrial network 536 and a gateway feed infrastructure 558 of gateway 556. It should be understood that in an example in which gateway service chain 556 provides only one-way communication, VNFs 554 may provide only a transmission path without providing a reception path. The set of VNFs 554 (e.g., implementing a gateway) on the forward path towards the link to satellite 520, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 554 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 500. The encapsulator may form baseband frames in accordance with the 5G standard, the DVB-S 2X standard, described in European Telecommunications Standards Institute (ETSI) European Standard (EN) 302 307-1 v1.4.1 (2014-11), among other possible standards. The encapsulator may comprise one or more VNFs 554 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 554, referred to as a virtualized traffic adaptor (vModem). The VNF-implemented combiner or a combiner 542 (implemented in hardware) may combine the signal data packets into a digital signal and provide the digital signal to a digitizer 540A, which may convert the digital signal into an analog signal.

The set of VNFs 554 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 554 on the reception path may convert a digital signal (such as a digital IF waveform or a composite digital IF waveform) to PDUs, which may be Ethernet frames or IP packets, among other possibilities. For example, the VNF-implemented channelizer or a channelizer 544 (implemented in hardware) may receive a digital signal from digitizer 540A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 536, to end point 530A. It should be understood that the demodulator performs the reverse function(s) of the modulator, and the decapsulator performs the reverse function(s) of the encapsulator. In an embodiment, the decapsulator and demodulator may be implemented as a single VNF 554, for example, together with the traffic handler, encapsulator, and modulator, in a vModem. In other words, a vModem may consist of a single VNF 554 that implements all of the functions of the traffic handler, encapsulator/decapsulator, and modulator/demodulator.

In some embodiments, in which gateway service chain 556 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 542 is transmitted to digitizer 540A, which converts the digital signal output by combiner 542 into an analog transmission signal for communication to satellite 520. Digitizer 540A further digitizes analog reception signals from satellite 520 into digital signals for use by channelizer 544. In some examples, digitizer 540A may be software-defined. As one example, digitizer 540A may be a SpectralNet™, which is a carrier-grade RF digitizer, offered by Kratos Defense & Security Solutions, Inc. of San Diego, California. Digitizer 540A communicates with antenna 550A. In particular, digitizer 540A provides the transmission signal to antenna 550A, which transmits the transmission signal to satellite 520. In addition, in two-way communications, antenna 550A receives a reception signal from satellite 520, and provides the reception signal to digitizer 540A.

In various examples, antenna 550A may be a parabolic reflector antenna, a flat panel antenna, a phased array antenna, a helical antenna, a patch antenna, a horn antenna, among other possibilities. In some examples, antenna 550A may be an electronically steered antenna that can use electronic means to control the direction and shape of its radiation pattern. Such an antenna can generate multiple beams simultaneously, allowing it to transmit or receive signals in multiple directions at the same time. Antenna 550A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 520 relays wireless signals from antenna 550A to antenna 550B. In two-way communications, satellite 520 also relays wireless signals from antenna 550B to antenna 550A. Antenna 550B may be functionally similar or identical to antenna 550A, and therefore, any description of antenna 550A applies equally to antenna 550B, which may not be redundantly described herein. Similarly, digitizer 540B may be functionally similar or identical to digitizer 540A, and therefore, any description of digitizer 540A applies equally to digitizer 540B, which may not be redundantly described herein.

Digitizer 540B may communicate directly with a terminal service chain 557 of a terminal compute infrastructure. Terminal service chain 557 may comprise a set of VNF(s) 555 forming a reception path from digitizer 540B to end point 530B. In two-way communications, terminal service chain 557 may also comprise a set of VNFs 555 forming a transmission path from end point 530B to digitizer 540B. The reception and transmission paths may be identical or similar to the reception and transmission paths described with respect to gateway service chain 556. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 556, and therefore, the descriptions of those components with respect to gateway service chain 556 apply equally to those components in terminal service chain 557.

Terminal service chain 557 may communicate with end point 530B. For example, the traffic handler of terminal service chain 557 may transmit Ethernet frames to end point 530B. In addition, in two-way communications, the encapsulator of terminal service chain 557 may receive PDUs from end point 530B. Thus, the combination of gateway service chain 556 and terminal service chain 557 enable one-way or two-way communications between end points 530A and 530B over a satellite link.

Gateway service chain 556 and terminal service chain 557 may comprise one or more of the software-defined components (e.g., VNFs and/or digitizers) described in International Patent App. Nos. PCT/US 2021/033867, filed on May 24, 2021, PCT/US 2021/033875, filed on May 24, 2021, PCT/US 2021/033905, filed on May 24, 2021, and PCT/US 2021/062689, filed on Dec. 9, 2021, which are all hereby incorporated herein by reference as if set forth in full.

Advantageously, the utilization of VNFs and software-defined components (e.g., digitizers 540A and 540B) to perform various functions, aid in automation and scalability. Embodiments may minimize the presence of physical hardware components, such that satellite communication system 500 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 500 on demand to ensure the sufficiency of the satellite communication system, but also to decrease the dimensions of the computing resources on demand to optimize the utilization of the hardware. For example, favorable changes in the satcom environment may improve performance of satellite communication system 500, such that satellite communication system 500 is providing significantly better performance than is required by the service level agreement. In this case, the management system may determine that gateway service chain 556 and terminal service chain 557 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

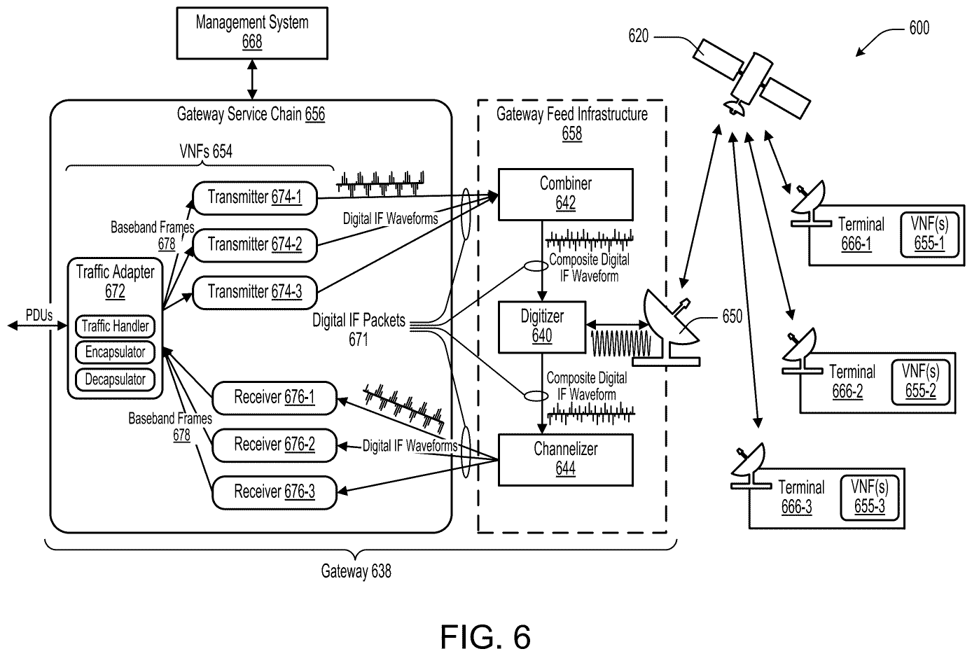

FIG. 6 illustrates an example satellite communication system 600 including a gateway 638 and a set of terminals 666 (or “remote terminals”), in accordance with some embodiments of the present disclosure. In the illustrated example, satellite communication system 600 includes a gateway 638 (or “hub”) in communication with each of terminals 666 via a satellite 620. Gateway 638 may include a gateway feed infrastructure 658 that serves as an onsite infrastructure (close to antenna 650, e.g., at a same physical location) that may perform primarily signal digitization and signal routing-related tasks and a gateway compute infrastructure that can be onsite or offsite infrastructure (far from antenna 650, e.g., at a different physical location) that supports a gateway service chain 656 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 658 may include general-purpose computers or servers employing x86 architectures, ARM architectures, RISC-V architectures, among other possibilities.

Gateway 638 may include a gateway service chain 656 comprising a set of VNFs 654 running on the gateway compute infrastructure. Examples of VNFs 654 include one or more traffic adapters 672, one or more virtual transmitters 674, one or more virtual receivers 676, among other possibilities. Each of VNFs 654 may be instantiated and configured by a management system 668 that scales up or down the number of active VNFs based on the number of active terminals 666. Management system 668 may further configure VNFs 654 such that satellite communication system 600 implements any one of a number of network topologies, including a single channel per carrier (SCPC) network, a TDMA network, a frequency division multiple access (FDMA) network, a mesh network, among other possibilities.

Traffic adapter 672 acts as the bridge between the terrestrial network and the satellite network. In some examples, traffic adapter 672 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 678 and provides baseband frames 678 to one of virtual transmitters 674. On the reception path, baseband frames 678 produced by virtual receivers 676 are received by the decapsulator of traffic adapter 672. The decapsulator may convert baseband frames 678 into Ethernet frames and pass the Ethernet frames to the traffic handler, which processes and provides the Ethernet frames to a terrestrial network.

Virtual transmitters 674 provide transmission paths between a terrestrial network and a gateway feed infrastructure 658 of gateway 656. Each of virtual transmitters 674 on a transmission path may comprise or constitute a forward error correction (FEC) encoder that adds redundant bits according to a particular error-correcting code and a modulator (e.g., the OpenSpace™ Wideband Software modulator) that converts incoming baseband frames 678 into digital IF packets 671 containing digital waveforms at IF or RF frequencies (or “digital IF waveforms”). Each of virtual transmitters 674 may implement a modulator that converts baseband frames 678 into digital IF packets 671 (e.g., according to the standards of the DIFI Consortium in the DIFI/IEEE 1.2 specification) to create the digital IF waveforms.

Digital IF packets 671 generated by virtual transmitters 674 may be fed into a combiner 642 that combines the multiple digital IF waveforms into a single composite signal (or “composite digital IF waveform”). Digital IF packets 671 containing the composite digital IF waveform is fed into a digitizer 640 that converts the digital signal into an analog signal in preparation for wireless transmission via an antenna 650. While combiner 642 is illustrated in FIG. 6 as being an element of gateway feed infrastructure 658, it is to be understood that a combiner VNF (or multiple combiner VNFs) may be instantiated by management system 668 to perform similar functionality.

On the reception path, digitizer 640 digitizes analog signals received from satellite 620 to generate digital IF packets 671 containing digital IF waveforms (e.g., a composite digital IF waveform) of the received analog signals for use by a channelizer 644. The composite digital IF waveform received by channelizer 644 may be a wide-band spectrum (e.g., 100 MHz, 500 MHz, 3 GHz, etc.) that may contain several signals within that segment of the frequency band. In some instances, channelizer 644 divides the composite digital IF waveform into separate digital IF waveforms and sends the waveforms (in the form of digital IF packets 671) to appropriate virtual receivers 676. While channelizer 644 is illustrated in FIG. 6 as being an element of gateway feed infrastructure 658, it is to be understood that a channelizer VNF (or multiple channelizer VNFs) may be instantiated by management system 668 to perform similar functionality.

Virtual receivers 676 provide reception paths between gateway feed infrastructure 658 and a terrestrial network. Each of the set of virtual receivers 676 on a reception path may comprise or constitute a demodulator (e.g., the OpenSpace™ Wideband Software Receiver) that converts incoming digital IF packets 671 containing digital IF waveforms into baseband frames 678 and an FEC decoder that receives the output of the demodulator and uses the redundant bits added by the FEC encoder to identify and correct any errors introduced during transmission. Baseband frames 678 produced by virtual receivers 676 are sent to the decapsulator of traffic adapter 672, which are then converted into Ethernet frames that are passed by the traffic handler to a terrestrial network.

Satellite 620 relays wireless signals from antenna 650 to the antennas of terminals 666, or vice versa. In two-way communications, satellite 620 also relays wireless signals from the antennas of terminals 666 to antenna 650. In some examples, each of terminals 666 may include hardware infrastructure to support one or more VNFs 655. In some examples, VNFs 655 at each of terminals 666 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 666.

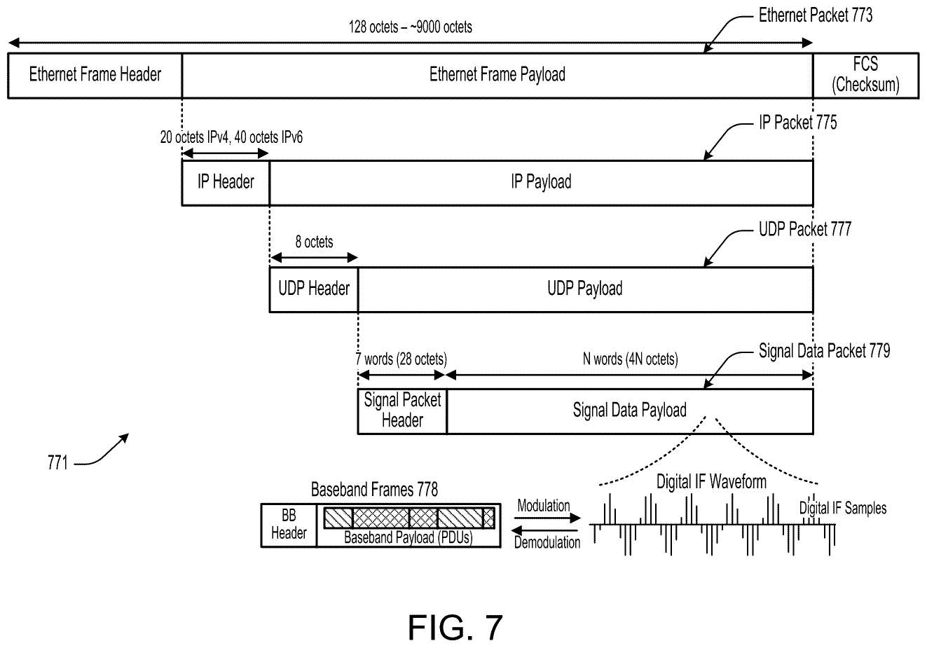

FIG. 7 illustrates an example digital IF packet 771 with multiple protocol layers, in accordance with some embodiments of the present disclosure. In the illustrated example, digital IF packet 771 includes a digital IF waveform contained within the signal data payload of a signal data packet 779. The digital IF waveform may represent the modulated form of one or more baseband frames 778 (or portions of one or more baseband frames 778), such that the baseband frames may be recovered by demodulating the digital IF waveform contained within the signal data payload. Signal data packet 779 may also include a signal packet header, which may implement the VITA standard (e.g., VITA 49.2 specification) or another standard.

In some examples, signal data packet 779 is encapsulated within a UDP packet 777 having a UDP header and UDP payload. UDP packet 777 may be encapsulated within an IP packet 775 having an IP header and IP payload, which may be encapsulated within an Ethernet packet 773 having an Ethernet frame header and Ethernet frame payload. In some examples, the total Ethernet packet size varies based on the number and size of the data samples in the signal data payload of signal data packet 779. There may be a fixed overhead within the Ethernet frame which comprises the IP header (20 octets for IPv4 or 40 octets (minimum) for IPv6), the UDP header (8 octets), the signal packet header (28 octets). In some examples, the Ethernet frame payload is adjustable from 128 octets to approximately 9000 octets.

In some examples, digital IF packet 771 may include different packet classes for signal data packet 779. In a first packet class, signal data packet 779 may be a regular data packet that includes the data for the digital samples forming the digital IF waveform. In a second packet class, signal data packet 779 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 779 may be a command packet that includes data used to provide and acknowledge device settings and support control of timing to permit synchronization of upstream or downstream devices.

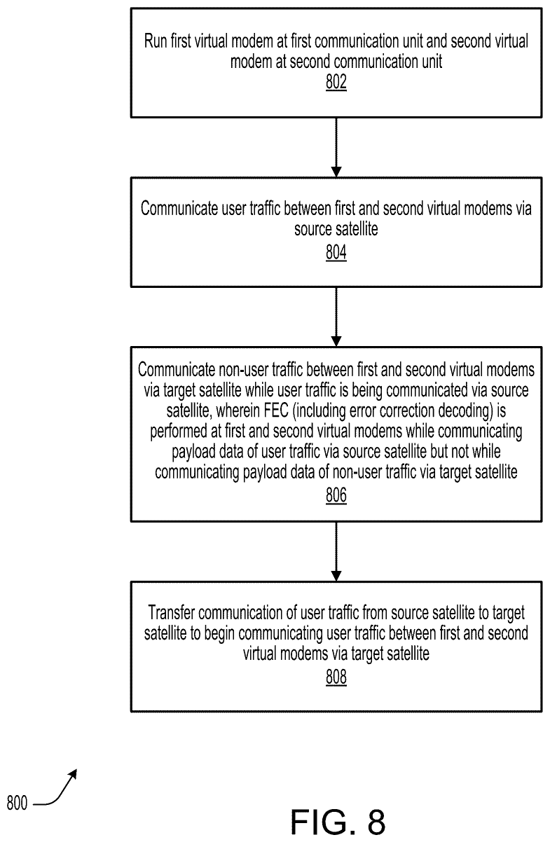

FIG. 8 illustrates an example method 800 of transferring communication from a source satellite (e.g., source satellites 120-1, 220-1, 320-1, 520, 620) to a target satellite (e.g., target satellites 120-2, 220-2, 320-2, 420, 520, 620), in accordance with some embodiments of the present disclosure. Steps of method 800 may be performed in any order and/or in parallel, and one or more steps of method 800 may be optionally performed. One or more steps of method 800 may be performed by one or more processors. Method 800 may be implemented as a computer-readable medium or computer program product comprising instructions which, when the program is executed by one or more processors, cause the one or more processors to carry out the steps of method 800.

Step 802 includes running a first virtual modem (e.g., virtual modems 222-1, 322-1) at a first communication unit and a second virtual modem (e.g., virtual modems 222-2, 322-2) at a second communication unit. The first communication unit may be a gateway (e.g., gateways 138, 238, 338, 538, 638) or a remote terminal (e.g., terminals 166, 266, 366, 566, 666). The second communication unit may independently be a gateway (e.g., gateways 138, 238, 338, 538, 638) or a remote terminal (e.g., terminals 166, 266, 366, 566, 666). In some examples, the first and second communication units may both be gateways or both be remote terminals. Each of the first virtual modem and the second virtual modem may include one or more VNFs (e.g., VNFs 154, 155, 554, 555, 654, 655).

Step 804 includes communicating user traffic (e.g., user traffic 136-1, 236-1, 336-1) between the first virtual modem and the second virtual modem via the source satellite. The user traffic may be communicated via the source satellite during a first time window. During the first time window, the first virtual modem may include a first virtual transmitter (e.g., virtual transmitters 274-1, 374-1) that includes a first error correction encoder (e.g., FEC encoder 324-1) and a first modulator (e.g., modulator 328-1) and a first virtual receiver (e.g., virtual receivers 276-1, 376-1) that includes a first error correction decoder (e.g., FEC decoder 326-1) and a first demodulator (e.g., demodulator 332-1). During the first time window, the second virtual modem may include a second virtual transmitter (e.g., virtual transmitters 274-2, 374-2) that includes a second error correction encoder (e.g., FEC encoder 324-2) and a second modulator (e.g., modulator 328-2) and a second virtual receiver (e.g., virtual receivers 276-2, 376-2) that includes a second error correction decoder (e.g., FEC decoder 326-2) and a second demodulator (e.g., demodulator 332-2).

Step 806 includes communicating non-user traffic (e.g., non-user traffic 146, 246, 346, 446) between the first virtual modem and the second virtual modem via the target satellite while the user traffic is being communicated via the source satellite. Step 806 further includes performing forward error correction (including error correction decoding) at the first virtual modem and the second virtual modem while communicating payload data of the user traffic via the source satellite but not while communicating payload data of the non-user traffic via the target satellite. The non-user traffic may include dummy frames having placeholder data. The non-user traffic may be communicated via the target satellite during a second time window that at least partially overlaps with the first time window. The dummy frames may be baseband dummy frames or physical layer dummy frames.

During the second time window, the first virtual modem may further include a third virtual transmitter (e.g., virtual transmitters 274-3, 374-3) that includes a third error correction encoder (e.g., FEC encoder 324-3) and a third modulator (e.g., modulator 328-3) and a third virtual receiver (e.g., virtual receiver 276-3, 376-3) that includes a third demodulator (e.g., demodulator 332-3). During the second time window, the second virtual modem may further include a fourth virtual transmitter (e.g., virtual transmitters 274-4, 374-4) that includes a fourth error correction encoder (e.g., FEC encoder 324-4) and a fourth modulator (e.g., modulator 328-4) and a fourth virtual receiver (e.g., virtual receivers 276-4, 376-4) that includes a fourth demodulator (e.g., demodulator 332-4).

Step 808 includes transferring communication of the user traffic (e.g., user traffic 136, 236, 336) from the source satellite to the target satellite to begin communicating the user traffic (e.g., user traffic 136-2, 236-2, 336-2) between the first virtual modem and the second virtual modem via the target satellite. The user traffic may be communicated via the target satellite during a third time window after the first time window and the second time window. During the third time window, the first virtual transmitter, the first virtual receiver, the second virtual transmitter, and the second virtual receiver may be terminated. During the third time window, the third virtual receiver may include a third FEC decoder (e.g., FEC decoder 326-3) and the fourth virtual receiver may include a fourth FEC decoder (e.g., FEC decoder 326-4).

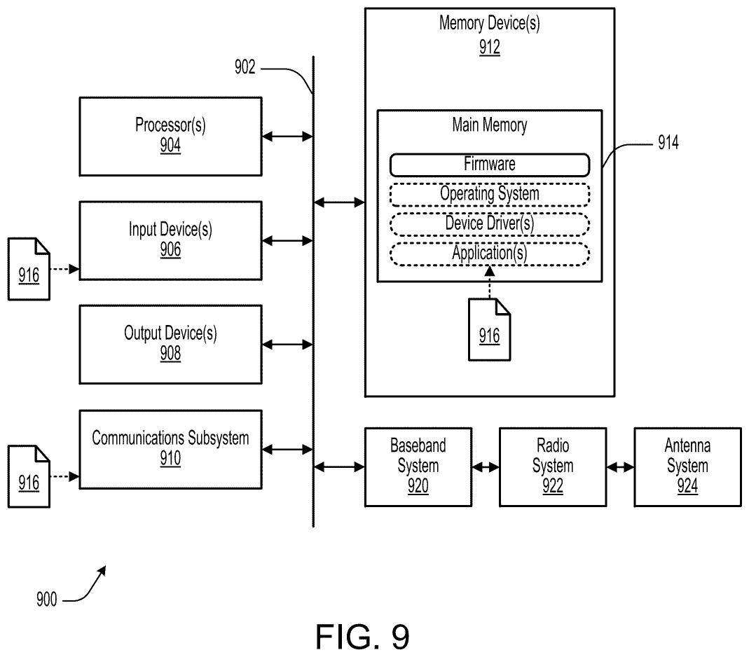

FIG. 9 illustrates an example computer system 900 comprising various hardware elements, in accordance with some embodiments of the present disclosure. Computer system 900 may be incorporated into or integrated with devices described herein and/or may be configured to perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

In the illustrated example, computer system 900 includes a communication medium 902, one or more processor(s) 904, one or more input device(s) 906, one or more output device(s) 908, a communications subsystem 910, one or more memory device(s) 912, a baseband system 920, a radio system 922, and an antenna system 924. Computer system 900 may be implemented using various hardware implementations and embedded system technologies. For example, one or more elements of computer system 900 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 900 may be communicatively coupled via communication medium 902. While communication medium 902 is illustrated as a single connection for purposes of clarity, it should be understood that communication medium 902 may include various numbers and types of communication media for transferring data between hardware elements. For example, communication medium 902 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 902 may include one or more buses that connect the pins of the hardware elements of computer system 900. For example, communication medium 902 may include a bus that connects processor(s) 904 with main memory 914, referred to as a system bus, and a bus that connects main memory 914 with input device(s) 906 or output device(s) 908, referred to as an expansion bus. The system bus may itself consist of several buses, including an address bus, a data bus, and a control bus. The address bus may carry a memory address from processor(s) 904 to the address bus circuitry associated with main memory 914 in order for the data bus to access and carry the data contained at the memory address back to processor(s) 904. The control bus may carry commands from processor(s) 904 and return status signals from main memory 914. Each bus may include multiple wires for carrying multiple bits of information and each bus may support serial or parallel transmission of data.

Processor(s) 904 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 904 may include one or more multi-core processors, in which each core may read and execute program instructions concurrently with the other cores, increasing speed for programs that support multithreading.

Input device(s) 906 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 906 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 908 may include one or more of various devices that convert information into human-readable form, such as without limitation a display device, a speaker, a printer, a haptic or tactile device, and/or the like. Output device(s) 908 may also include devices for writing to removable storage devices or other removable media, such as those described in reference to input device(s) 906. Output device(s) 908 may also include various actuators for causing physical movement of one or more components. Such actuators may be hydraulic, pneumatic, electric, and may be controlled using control signals generated by computer system 900.

Communications subsystem 910 may include hardware components for connecting computer system 900 to systems or devices that are located external to computer system 900, such as over a computer network. In various embodiments, communications subsystem 910 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 912 may include the various data storage devices of computer system 900. For example, memory device(s) 912 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 904 and memory device(s) 912 are illustrated as being separate elements, it should be understood that processor(s) 904 may include varying levels of on-processor memory, such as processor registers and caches that may be utilized by a single processor or shared between multiple processors.

Memory device(s) 912 may include main memory 914, which may be directly accessible by processor(s) 904 via the address and data buses of communication medium 902. For example, processor(s) 904 may continuously read and execute instructions stored in main memory 914. As such, various software elements may be loaded into main memory 914 to be read and executed by processor(s) 904 as illustrated in FIG. 9. Typically, main memory 914 is volatile memory, which loses all data when power is turned off and accordingly needs power to preserve stored data. Main memory 914 may further include a small portion of non-volatile memory containing software (e.g., firmware, such as BIOS) that is used for reading other software stored in memory device(s) 912 into main memory 914. In some embodiments, the volatile memory of main memory 914 is implemented as RAM, such as dynamic random-access memory (DRAM), and the non-volatile memory of main memory 914 is implemented as read-only memory (ROM), such as flash memory, erasable programmable read-only memory (EPROM), or electrically erasable programmable read-only memory (EEPROM).

Computer system 900 may include software elements, shown as being currently located within main memory 914, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 916, which are executable by computer system 900. In one example, such instructions 916 may be received by computer system 900 using communications subsystem 910 (e.g., via a wireless or wired signal that carries instructions 916), carried by communication medium 902 to memory device(s) 912, stored within memory device(s) 912, read into main memory 914, and executed by processor(s) 904 to perform one or more steps of the described methods. In another example, instructions 916 may be received by computer system 900 using input device(s) 906 (e.g., via a reader for removable media), carried by communication medium 902 to memory device(s) 912, stored within memory device(s) 912, read into main memory 914, and executed by processor(s) 904 to perform one or more steps of the described methods.

Computer system 900 may include optional wireless communication components that facilitate wireless communication over a voice network and/or a data network. The wireless communication components comprise an antenna system 924, a radio system 922, and a baseband system 920. In computer system 900, RF signals are transmitted and received over the air by antenna system 924 under the management of radio system 922. In an embodiment, antenna system 924 may comprise one or more antennae and one or more multiplexors (not shown) that perform a switching function to provide antenna system 924 with transmit and receive signal paths. In the reception path, received RF signals can be coupled from a multiplexor to a low noise amplifier (not shown) that amplifies the received RF signal and sends the amplified signal to radio system 922. In an alternative embodiment, radio system 922 may comprise one or more radios that are configured to communicate over various frequencies. In an embodiment, radio system 922 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 922 to baseband system 920.

In some embodiments of the present disclosure, instructions 916 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 900. For example, the non-transitory computer-readable medium may be one of memory device(s) 912 (as shown in FIG. 9). In some cases, the non-transitory computer-readable medium may be separate from computer system 900. In one example, the non-transitory computer-readable medium may be a removable medium provided to input device(s) 906 (as shown in FIG. 9), such as those described in reference to input device(s) 906, with instructions 916 being read into computer system 900 by input device(s) 906. In another example, the non-transitory computer-readable medium may be a component of a remote electronic device, such as a mobile phone, that may wirelessly transmit a data signal that carries instructions 916 to computer system 900 and that is received by communications subsystem 910 (as shown in FIG. 9).

Instructions 916 may take any suitable form to be read and/or executed by computer system 900. For example, instructions 916 may be source code (written in a human-readable programming language such as Java, C, C++, C #, Python), object code, assembly language, machine code, microcode, executable code, and/or the like. In one example, instructions 916 are provided to computer system 900 in the form of source code, and a compiler is used to translate instructions 916 from source code to machine code, which may then be read into main memory 914 for execution by processor(s) 904. As another example, instructions 916 are provided to computer system 900 in the form of an executable file with machine code that may immediately be read into main memory 914 for execution by processor(s) 904. In various examples, instructions 916 may be provided to computer system 900 in encrypted or unencrypted form, compressed or uncompressed form, as an installation package or an initialization for a broader software deployment, among other possibilities.

In one aspect of the present disclosure, a system (e.g., computer system 900) is provided to perform methods in accordance with various embodiments of the present disclosure. For example, some embodiments may include a system comprising one or more processors (e.g., processor(s) 904) that are communicatively coupled to a non-transitory computer-readable medium (e.g., memory device(s) 912 or main memory 914). The non-transitory computer-readable medium may have instructions (e.g., instructions 916) stored therein that, when executed by the one or more processors, cause the one or more processors to perform the methods described in the various embodiments.

In another aspect of the present disclosure, a computer-program product that includes instructions (e.g., instructions 916) is provided to perform methods in accordance with various embodiments of the present disclosure. The computer-program product may be tangibly embodied in a non-transitory computer-readable medium (e.g., memory device(s) 912 or main memory 914). The instructions may be configured to cause one or more processors (e.g., processor(s) 904) to perform the methods described in the various embodiments.

In another aspect of the present disclosure, a non-transitory computer-readable medium (e.g., memory device(s) 912 or main memory 914) is provided. The non-transitory computer-readable medium may have instructions (e.g., instructions 916) stored therein that, when executed by one or more processors (e.g., processor(s) 904), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of transferring communication from a source satellite to a target satellite, the method comprising:
running a first virtual modem at a first communication unit and a second virtual modem at a second communication unit;
communicating user traffic between the first virtual modem and the second virtual modem via the source satellite;
communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and
transferring communication of the user traffic from the source satellite to the target satellite to begin communicating the user traffic between the first virtual modem and the second virtual modem via the target satellite.

2. The method of claim 1, wherein the first communication unit is a gateway and the second communication unit is a terminal.

3. The method of claim 1, wherein the user traffic is communicated via the source satellite using a first antenna of the first communication unit and the non-user traffic is communicated via the target satellite using a second antenna of the first communication unit.

4. The method of claim 1, wherein the non-user traffic comprises dummy frames.

5. The method of claim 4, wherein communicating the non-user traffic via the target satellite includes:
performing, at the first virtual modem and the second virtual modem, error correction encoding to header data of the dummy frames; and
performing, at the first virtual modem and the second virtual modem, error correction decoding to the header data of the dummy frames.

6. The method of claim 1, wherein:
the user traffic is communicated via the source satellite during a first time window;
the non-user traffic is communicated via the target satellite during a second time window that at least partially overlaps with the first time window; and
the user traffic is communicated via the target satellite during a third time window after the first time window and the second time window.

7. The method of claim 6, wherein, during the first time window:
the first virtual modem includes:
a first virtual transmitter that includes a first error correction encoder and a first modulator; and
a first virtual receiver that includes a first error correction decoder and a first demodulator; and
the second virtual modem includes:
a second virtual transmitter that includes a second error correction encoder and a second modulator; and
a second virtual receiver that includes a second error correction decoder and a second demodulator.

8. The method of claim 7, wherein, during the second time window:
the first virtual modem further includes:
a third virtual transmitter that includes a third error correction encoder and a third modulator; and
a third virtual receiver that includes a third demodulator; and
the second virtual modem further includes:
a fourth virtual transmitter that includes a fourth error correction encoder and a fourth modulator; and
a fourth virtual receiver that includes a fourth demodulator.

9. One or more non-transitory computer-readable media comprising instructions that, when executed by one or more processors, cause the one or more processors to perform operations for transferring communication from a source satellite to a target satellite, the operations comprising:
running a first virtual modem at a first communication unit and a second virtual modem at a second communication unit;
communicating user traffic between the first virtual modem and the second virtual modem via the source satellite;
communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and
transferring communication of the user traffic from the source satellite to the target satellite to begin communicating the user traffic between the first virtual modem and the second virtual modem via the target satellite.

10. The one or more non-transitory computer-readable media of claim 9, wherein the first communication unit is a gateway and the second communication unit is a terminal.

11. The one or more non-transitory computer-readable media of claim 9, wherein the user traffic is communicated via the source satellite using a first antenna of the first communication unit and the non-user traffic is communicated via the target satellite using a second antenna of the first communication unit.

12. The one or more non-transitory computer-readable media of claim 9, wherein the non-user traffic comprises dummy frames.

13. The one or more non-transitory computer-readable media of claim 12, wherein communicating the non-user traffic via the target satellite includes:
performing, at the first virtual modem and the second virtual modem, error correction encoding to header data of the dummy frames; and
performing, at the first virtual modem and the second virtual modem, error correction decoding to the header data of the dummy frames.

14. The one or more non-transitory computer-readable media of claim 9, wherein:
the user traffic is communicated via the source satellite during a first time window;
the non-user traffic is communicated via the target satellite during a second time window that at least partially overlaps with the first time window; and
the user traffic is communicated via the target satellite during a third time window after the first time window and the second time window.

15. The one or more non-transitory computer-readable media of claim 14, wherein, during the first time window:
the first virtual modem includes:
a first virtual transmitter that includes a first error correction encoder and a first modulator; and
a first virtual receiver that includes a first error correction decoder and a first demodulator; and
the second virtual modem includes:
a second virtual transmitter that includes a second error correction encoder and a second modulator; and
a second virtual receiver that includes a second error correction decoder and a second demodulator.

16. The one or more non-transitory computer-readable media of claim 15, wherein, during the second time window:
the first virtual modem further includes:
a third virtual transmitter that includes a third error correction encoder and a third modulator; and
a third virtual receiver that includes a third demodulator; and
the second virtual modem further includes:
a fourth virtual transmitter that includes a fourth error correction encoder and a fourth modulator; and
a fourth virtual receiver that includes a fourth demodulator.

17. A system comprising:
one or more processors; and
one or more computer-readable media comprising instructions that, when executed by the one or more processors, cause the one or more processors to perform operations for transferring communication from a source satellite to a target satellite, the operations comprising:
running a first virtual modem at a first communication unit and a second virtual modem at a second communication unit;
communicating user traffic between the first virtual modem and the second virtual modem via the source satellite;
communicating non-user traffic between the first virtual modem and the second virtual modem via the target satellite while the user traffic is being communicated via the source satellite, wherein error correction decoding is performed at the first virtual modem and the second virtual modem while communicating payload data of the user traffic via the source satellite but not while communicating payload data of the non-user traffic via the target satellite; and
transferring communication of the user traffic from the source satellite to the target satellite to begin communicating the user traffic between the first virtual modem and the second virtual modem via the target satellite.

18. The system of claim 17, wherein the first communication unit is a gateway and the second communication unit is a terminal.

19. The system of claim 17, wherein the user traffic is communicated via the source satellite using a first antenna of the first communication unit and the non-user traffic is communicated via the target satellite using a second antenna of the first communication unit.

20. The system of claim 17, wherein the non-user traffic comprises dummy frames.
